(19) United States
(12) Patent Application Publication
(10) Pub. No.: US 2013/0335203 A1
(43) Pub. Date: Dec. 19, 2013

(54) PORTABLE ELECTRONIC DEVICE FOR REMOTELY CONTROLLING SMART HOME ELECTRONIC DEVICES AND METHOD THEREOF

(71) Applicants: Yan Long Sun, Hangzhou City (CN); Jin Huang, Hangzhou City (CN); YaGuang Xie, Hangzhou City (CN)

(72) Inventors: Yan Long Sun, Hangzhou City (CN); Jin Huang, Hangzhou City (CN); YaGuang Xie, Hangzhou City (CN)

(21) Appl. No.: 13/526,543

(22) Filed: Jun. 19, 2012

(51) Int. Cl. G05B 11/01

(52) U.S. Cl. 340/12.5

(57) ABSTRACT

Generate a first motion signal when a first predetermined movement of the portable electronic device is detected. Generate a first command corresponding to the first motion signal. Link the portable electronic device to a plurality of smart home electronic devices via a wireless network according to the first command. List the plurality of smart home electronic devices on the portable electronic device. Generate a second motion signal when a second predetermined movement of the portable electronic device is detected. Generate a second command corresponding to the second motion signal. Control a smart home electronic device selected from the plurality of smart home electronic devices according to the second command.

### BACKGROUND OF THE INVENTION

1. Field of the Invention

The present invention is related to a remote control method, and more particularly to a method of using a portable electronic device to remotely control a smart home electronic device.

2. Description of the Prior Art

Generally speaking, the meaning of a smart home is similar to that of a home automation, an electronic home, a digital family, a home net, a network home, an intelligent home, an intelligent building, etc. A main distinctive feature of the smart home is that a communication network is installed therein. This allows various smart home electronic devices in the smart home to be linked via the communication network.

A user can control these smart home electronic devices by controllers away from these smart home electronic devices remotely. However, most controllers in the smart home are dedicated devices or panels for controlling dedicated electronics and are not compatible to other electronics. Besides, as more and more new functions such as browsing web pages, watching streaming videos, and playing video games are added in a smart television, more and more buttons are required to be displayed on controllers' screens for the user to access and control these new functions. However displaying too many buttons on controllers' screens is not only complicate and non-intuitive for the user but also confuses the user.

### SUMMARY OF THE INVENTION

An embodiment of the present invention discloses a method of using a portable electronic device to remotely control a smart home electronic device. The method comprises generating a first motion signal when a first predetermined movement of the portable electronic device is detected, generating a first command corresponding to the first motion signal, linking the portable electronic device to a plurality of smart home electronic devices via a wireless network according to the first command, listing the plurality of smart home electronic devices on the portable electronic device, generating a second motion signal when a second predetermined movement of the portable electronic device is detected, generating a second command corresponding to the second motion signal, and controlling the smart home electronic device selected from the plurality of smart home electronic devices according to the second command.

Another embodiment of the present invention discloses a portable electronic device for remotely controlling a smart home electronic device. The device comprises a housing, a touch screen, a motion sensor, a controller, and a wireless module. The touch screen is for receiving an input signal. The motion sensor is for detecting a predetermined movement of the portable electronic device to generate a motion signal. The controller is for generating a command corresponding to the motion signal or the input signal. The wireless module is for linking with the smart home electronic device and transmitting the command to control the smart home electronic device.

Another embodiment of the present invention discloses a remote control system. The system comprises a portable electronic device and a smart home electronic device. The portable electronic device comprises a housing, a touch screen, a motion sensor, a controller, and a wireless module. The touch screen is for receiving an input signal. The motion sensor is for detecting a predetermined movement of the portable electronic device to generate a motion signal. The controller is for generating a command corresponding to the motion signal or the input signal. The wireless module is for linking with the smart home electronic device and transmitting the command to control the smart home electronic device. The smart home electronic device comprises a wireless receiver for receiving the command from the wireless module of the portable electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a remote control system 100 according to an embodiment of the present invention.

FIG. 2 is a flowchart illustrating a method of using a portable electronic device to remotely control a smart home electronic device according to an embodiment of FIG. 1.

FIG. 3 is a flowchart illustrating a method of using a portable electronic device to remotely control a smart home electronic device according to another embodiment of FIG. 1.

### DETAILED DESCRIPTION

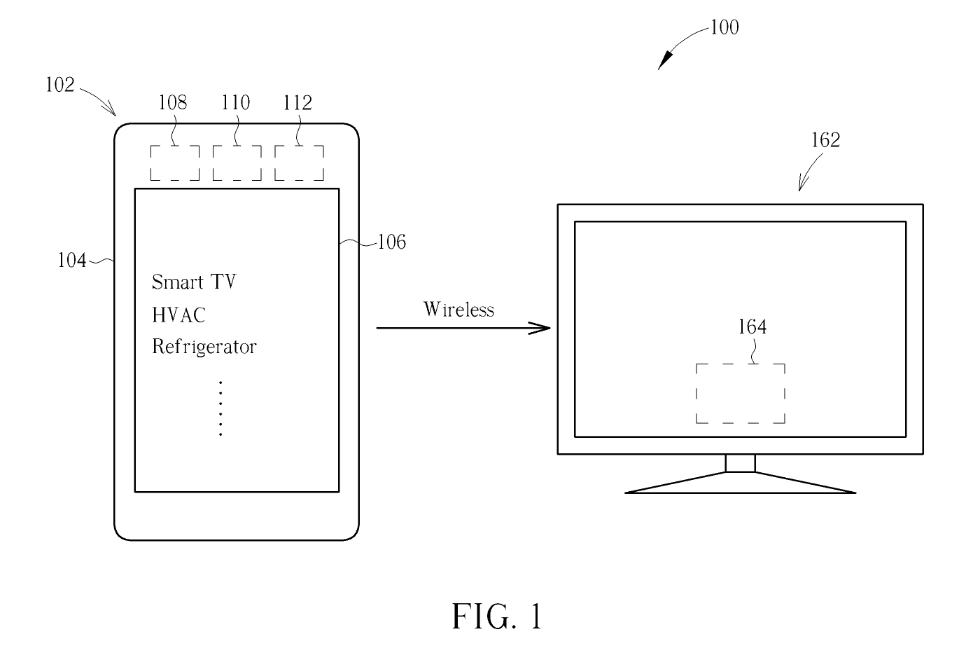

FIG. 1 is a block diagram illustrating a remote control system 100 according to an embodiment of the present invention. The system 100 includes a portable electronic device 102 and a smart home electronic device 162. The portable electronic device 102 may be a smart phone or a tablet computer. The portable electronic device 102 may include a hosing 104, a touch screen 106, a motion sensor 108, a controller 110, and a wireless module 112. The touch screen 106 is used for receiving an input signal. The motion sensor 108 is used for detecting a predetermined movement of the portable electronic device 102 to generate a motion signal. The controller 110 is used for generating a command corresponding to the motion signal or the input signal. The wireless module 112 is used for linking with the smart home electronic device 162 and transmitting the command to control the smart home electronic device 162.

The motion sensor 108 may include an accelerometer, a gyroscope, a proximity sensor, a magnetometer, and/or a GPS (global positioning system) sensor. The accelerometer is used for detecting an orientation and/or an acceleration of the portable electronic device 102. The gyroscope is used for detecting an angular velocity of the portable electronic device 102. The proximity sensor is used for measuring the distance between an object and the portable electronic device 102. The magnetometer is used for detecting a direction of the portable electronic device 102 with regard to a geomagnetic north pole. The GPS sensor is used for locating a position of the portable electronic device 102. The wireless module 112 may include a Wi-Fi (wireless fidelity) module and/or a Bluetooth module.

The smart home electronic device 162 maybe an HVAC (heating, ventilation and air conditioning) system, a heater, an air conditioner, a lighting device, a coffeemaker, a tea maker, a refrigerator, a garage door, a smart TV (television), a pet feeding and watering device, a plant watering device, a pool pump, a Jacuzzi, and other smart home electronic devices equipped with a wireless receiver 164 for receiving the command from the portable electronic device 102. The wireless receiver 164 may include a Wi-Fi (wireless fidelity) module and/or a Bluetooth module.

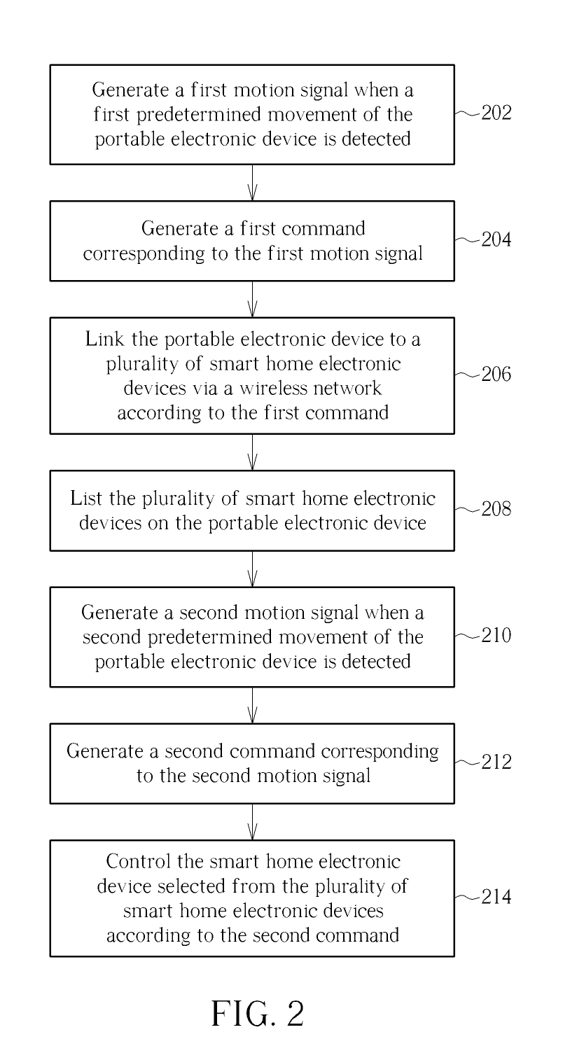

FIG. 2 is a flowchart illustrating a method 200 of using a portable electronic device 102 to remotely control a smart home electronic device 162 according to an embodiment of FIG. 1 of the present invention. The method 200 may include the following steps:

Step 202: Generate a first motion signal when a first predetermined movement of the portable electronic device 102 is detected;

Step 204: Generate a first command corresponding to the first motion signal;

Step 206: Link the portable electronic device 102 to a plurality of smart home electronic devices via a wireless network according to the first command;

Step 208: List the plurality of smart home electronic devices on the portable electronic device 102;

Step 210: Generate a second motion signal when a second predetermined movement of the portable electronic device 102 is detected;

Step 212: Generate a second command corresponding to the second motion signal;

Step 214: Control the smart home electronic device 162 selected from the plurality of smart home electronic devices according to the second command.

First a user may install software dedicated to remotely controlling the smart home electronic device 162 on the portable electronic device 102. Then the user may run the software to define or customize the first predetermined movement of the portable electronic device 102 with the utilization the motion sensor 108. Thereby, when the user moves the portable electronic device 102 with the first predetermined movement, the first predetermined movement may be detected by the motion sensor 108 and the first motion signal may be generated by the motion sensor 108, then the first command is generated by the controller 110 according to the first motion signal for controlling the portable electronic device 102 to start searching and establishing links with available smart home electronic devices via a wireless network. The links may be established with available smart home electronic devices in a same room, in different rooms, or even in a distant location through a wireless communication network.

Next, the portable electronic device 102 may automatically list those available smart home electronic devices on the touch screen 106 for the user to select one of those smart home electronic devices that the user wants to control, which may be the smart home electronic device 162 in FIG. 1. There are many ways for the user to select which smart home electronic device to be controlled. For example, without limitation thereto, the user may customize a specific movement to select which one to be controlled.

The user may run the software to define or customize the second predetermined movement of the portable electronic device 102 with the utilization of the motion sensor 108. Thereby, when the user moves the portable electronic device 102 with the second predetermined movement, the second predetermined movement may be detected by the motion sensor 108 and the second motion signal may be generated by the motion sensor 108, then the second command is generated by the controller 110 according to the second motion signal and the controller 110 sends the second command through the wireless module 112 to the wireless receiver 164 of the smart home electronic device 162 to control the smart home electronic device 162 via the wireless network.

The second predetermined movement may include a plurality of different motions such as shaking, turning, moving up, moving down, etc. of the portable electronic device 102 for controlling the smart home electronic device 162 to perform different functions corresponding to the plurality of different motions. The user may customize the plurality of different motions to the user's liking. For example, a first kind of the plurality of different motions may be used to activate the smart home electronic device 162 such as turning on the lighting device, the air conditioner, the smart TV, etc. A second kind of the plurality of different motions may be used to deactivate the smart home electronic device 162 such as turning off the lighting device, the air conditioner, the smart TV, etc. Other kinds of the plurality of different motions may be used to control other corresponding functions, such as adjusting levels of volume, temperature, timing, lighting, etc. of the smart home electronic device 162. Since the motion sensor 108 may include the GPS sensor, another kind of motion may be used to control the garage door such as opening the garage door when the portable electronic device 102 is getting closer to the garage door.

If the user wants to disconnect the link between the portable electronic device 102 and the smart home electronic device 162, the user may run the software to customize a third predetermined movement of the portable electronic device 102 with the utilization of the motion sensor 108 or to set a predetermined time of a timer of the portable electronic device 102. Thereby, when the third predetermined movement is detected or the predetermined time is reached, the portable electronic device 102 may disconnect with the smart home electronic device 162.

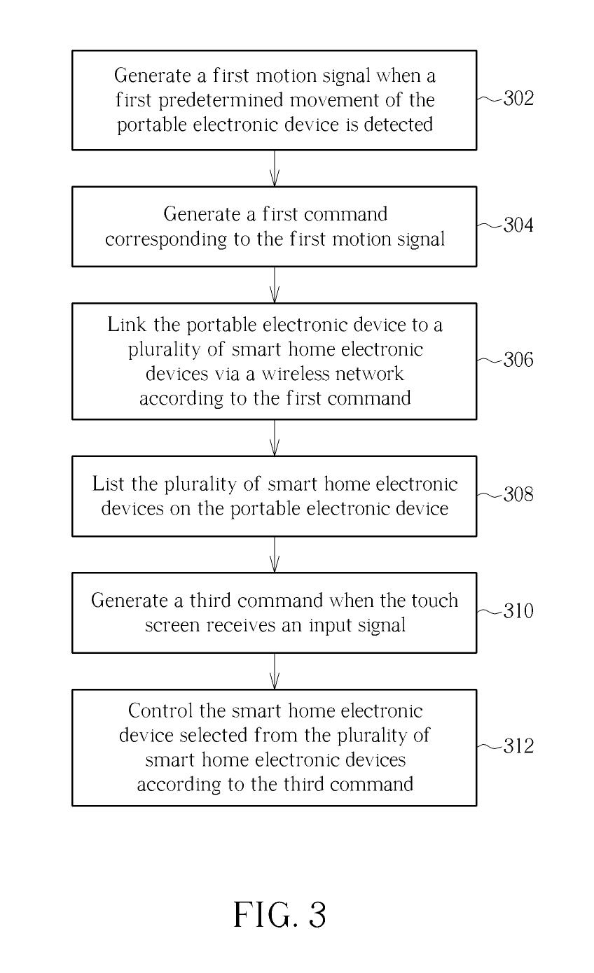

FIG. 3 is a flowchart illustrating a method 300 of using a portable electronic device 102 to remotely control a smart home electronic device 162 according to another embodiment of FIG. 1 of the present invention. The method 300 may include the following steps:

Step 302: Generate a first motion signal when a first predetermined movement of the portable electronic device 102 is detected;

Step 304: Generate a first command corresponding to the first motion signal;

Step 306: Link the portable electronic device 102 to a plurality of smart home electronic devices via a wireless network according to the first command;

Step 308: List the plurality of smart home electronic devices on the portable electronic device 102;

Step 310: Generate a third command when the touch screen 106 receives an input signal;

Step 312: Control the smart home electronic device 162 selected from the plurality of smart home electronic devices according to the third command.

If the selected smart home electronic device 162 is the smart TV, both the method 200 and the method 300 may be used to control the smart TV. The second predetermined movement may include a plurality of different motions of the portable electronic device 102 for controlling the smart TV to perform different functions corresponding to the plurality of different motions. Thus the user may customize the plurality of different motions to the user's liking. For example, without limitation thereto, if the user wants to move a cursor on a screen of the smart TV to a certain position, the user may move the portable electronic device 102 upward, downward, leftward, or rightward to control 2D (two dimension) movements of the cursor. If the smart TV is 3D (three dimension) TV, the user may move the portable electronic device 102 forward or backward toward the 3D TV to control an extra dimension movements of the cursor in addition to 2D movements. The user may rotate the portable electronic device 102 clockwise or counterclockwise to control a rotation of a 3D object on the screen of the 3D TV by utilizing the gyroscope of the motion sensor 108. Further the user may also move hands close to or away from the portable electronic device 102 to zoom in or zoom out an object on the screen of the smart TV by utilizing the proximity sensor of the motion sensor 108.

When the user touches the touch screen 106, the touch screen 106 receives the input signal. Then the controller 110 generates the third command corresponding to the input signal and sends the third command through the wireless module 112 to the wireless receiver 164 of the smart TV to control the smart TV via the wireless network. For example, without limitation thereto, the user may drag the object on the screen of the smart TV by pressing a location on the touch screen 106 corresponding to the object and dragging the object to a desired location. After the object is dragged to the desired location, the user may un-press the touch screen 106 to drop the object. In addition, the user may click or double click the touch screen 106 to emulate mouse functions on the screen of the smart TV.

In summary, the present invention provides a method of using movements of the portable electronic device 102 to remotely control the smart home electronic device 162, where each movement may control a corresponding function of the smart home electronic device 162. Further the software installed in portable electronic device is compatible to a variety of smart home electronic devices and may be upgraded with new functions. Thus the method is not only intuitive to the user by sparing the user the trouble of accessing too many dedicated controllers with too many buttons on them but also compatible to a variety of smart home electronic devices with no additional dedicated devices or panels required. Sensors such as accelerometer, gyroscope, proximity sensor, magnetometer, and GPS sensor are precise enough to sense movements of the portable electronic device 102 and are popularly equipped in the smart phone or the tablet computer. Thus the method achieves precise control ability. In addition, the method accommodates a variety of ways of accessing and controlling new functions such as browsing web pages by utilizing the touch screen 106.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of using a portable electronic device to remotely control a smart home electronic device comprising:
generating a first motion signal when a first predetermined movement of the portable electronic device is detected;
generating a first command corresponding to the first motion signal;
linking the portable electronic device to a plurality of smart home electronic devices via a wireless network according to the first command;
listing the plurality of smart home electronic devices on the portable electronic device;
generating a second motion signal when a second predetermined movement of the portable electronic device is detected;
generating a second command corresponding to the second motion signal; and
controlling the smart home electronic device selected from the plurality of smart home electronic devices according to the second command.

2. The method of claim 1 wherein generating the first motion signal when the first predetermined movement of the portable electronic device is detected is generating the first motion signal by a motion sensor when the first predetermined movement of the portable electronic device is detected by the motion sensor.

3. The method of claim 1 wherein generating the second motion signal when the second predetermined movement of the portable electronic device is detected is generating the second motion signal by a motion sensor when the second predetermined movement of the portable electronic device is detected by the motion sensor.

4. The method of claim 1 wherein controlling the smart home electronic device according to the second command is controlling the smart home electronic device according to the second command via the wireless network.

5. The method of claim 1 wherein listing the plurality of smart home electronic devices on the portable electronic device is listing the plurality of smart home electronic devices on a touch screen of the portable electronic device.

6. The method of claim 5 further comprising:
generating a third command when the touch screen receives an input signal; and
controlling the smart home electronic device selected from the plurality of smart home electronic devices according to the third command.

7. A portable electronic device for remotely controlling a smart home electronic device comprising:
a housing;
a touch screen disposed on the housing for receiving an input signal;
a motion sensor disposed in the housing for detecting a predetermined movement of the portable electronic device to generate a motion signal;
a controller disposed in the housing for generating a command corresponding to the motion signal or the input signal; and
a wireless module disposed in the housing for linking with the smart home electronic device and transmitting the command to control the smart home electronic device.

8. The portable electronic device of claim 7 wherein the motion sensor comprises:
an accelerometer for detecting an orientation and/or an acceleration of the portable electronic device.

9. The portable electronic device of claim 7 wherein the motion sensor comprises:
a gyroscope for detecting an angular velocity of the portable electronic device.

10. The portable electronic device of claim 7 wherein the motion sensor comprises:
a proximity sensor for measuring the distance between an object and the portable electronic device.

11. The portable electronic device of claim 7 wherein the motion sensor comprises:
a magnetometer for detecting a direction of the portable electronic device with regard to a geomagnetic north pole.

12. The portable electronic device of claim 7 wherein the motion sensor comprises:
a GPS (global positioning system) sensor for locating a position of the portable electronic device.

13. The portable electronic device of claim 7 wherein the wireless module is a Wi-Fi (wireless fidelity) module.

14. The portable electronic device of claim 7 wherein the wireless module is a Bluetooth module.

15. A remote control system comprising:
a portable electronic device for remotely controlling a smart home electronic device comprising:
a housing;
a touch screen disposed on the housing for receiving an input signal;
a motion sensor disposed in the housing for detecting a predetermined movement of the portable electronic device to generate a motion signal;
a controller disposed in the housing for generating a command corresponding to the motion signal or the input signal; and
a wireless module disposed in the housing for linking with the smart home electronic device and transmitting the command to control the smart home electronic device; and
a smart home electronic device comprising:
a wireless receiver for receiving the command from the wireless module of the portable electronic device.

16. The remote control system of claim 15 wherein the motion sensor comprises:
an accelerometer for detecting an orientation and/or an acceleration of the portable electronic device.

17. The remote control system of claim 15 wherein the motion sensor comprises:
a gyroscope for detecting an angular velocity of the portable electronic device.

18. The remote control system of claim 15 wherein the motion sensor comprises:
a proximity sensor for measuring the distance between an object and the portable electronic device.

19. The remote control system of claim 15 wherein the motion sensor comprises:
a magnetometer for detecting a direction of the portable electronic device with regard to a geomagnetic north pole.

20. The portable electronic device of claim 15 wherein the motion sensor comprises:
a GPS sensor for locating a position of the portable electronic device.

21. The remote control system of claim 15 wherein the wireless module is a Wi-Fi module and the wireless receiver is a Wi-Fi receiver.

22. The remote control system of claim 15 wherein the wireless module is a Bluetooth module and the wireless receiver is a Bluetooth receiver.
